(19) United States
(12) Patent Application Publication
(10) Pub. No.: US 2010/0301627 A1
(43) Pub. Date: Dec. 2, 2010

(54) MOTORCYCLE WITH AN AUTOMATIC AIR DEFLECTOR

(75) Inventor: B. T. Kern, Lebanon, TN (US)

Correspondence Address: BRADLEY ARANT BOULT CUMMINGS LLP, 200 CLINTON AVE. WEST, SUITE 900, HUNTSVILLE, AL, 35801, US

(73) Assignee: Nu-Tek Inventions, LLC, Lebanon, TN (US)

(21) Appl. No.: 12/474,721

(22) Filed: May 29, 2009

(51) Int. Cl. B62J 17/00

(52) U.S. Cl. 296/78.1

(57) ABSTRACT

A fairing upper moves with a steering assembly pivotably connected to the frame of a motorcycle. An engine guard is connected to the motorcycle frame, and a fairing lower is connected to the engine guard. A deflector is positioned adjacent to the fairing lower. The deflector includes a hinge, so the deflector has a closed hinge position and an open hinge position. A spring urges the deflector toward the closed hinge position. The spring is tensioned such that when the motorcycle reaches an open speed, wind resistance overcomes the spring tension and moves the deflector from the closed hinge position to the open hinge position.

### BACKGROUND OF THE INVENTION

a. Field of the Invention

This invention relates to deflectors employing the science of aerodynamics for controlling and directing air flow on motorcycles.

b. Description of the Related Art

Motorcycles are used in a wide variety of conditions, including windy conditions, heavy traffic, rainy conditions, and hot conditions. Motorcycles are driven near semi trucks producing significant wind shear and turbulent air, which has an impact on the motorcycle. Motorcycles can also be used in inclement weather, such as during rainfall. There are wet roads which can draw water up and present hazards to the rider, and there are a multitude of other conditions in which motorcycles can be used. A motorcycle rider must cope with the conditions present when riding.

Devices or techniques which improve the ability of the rider to utilize the motorcycle in varied conditions are desirable. Generally, motorcycle riders prefer safer conditions, and some devices can produce safer conditions. For example, a device which reduces the effects of turbulence for a motorcycle, where the turbulence might be caused by high winds, semi trucks or other nearby traffic. Turbulence can also be caused by the normal air flow around a motorcycle as it moves through the air, or by objects beside the road, such as large signs or buildings. Another example is a device which reduces the effects of wind or precipitation on the rider. A device which aerodynamically directs air flow and reduces the amount of rain impacting the rider provides greater rider comfort, and less fatigue from adverse conditions. A device which minimizes the wind felt by the rider can also improve safety, because long-term exposure to wind can be tiring.

There are certain motorcycle products currently available to improve rider safety and comfort in varied conditions. These products can include windshields, which can be either free standing or mounted with fairings. There are fairings with a wide variety of styles, shapes and colors. Fairings are attachments used to protect the rider and direct air flow around the motorcycle. Fairings are typically attached to the motorcycle and essentially become a part of the motorcycle. Many riders also use helmets, and helmets can include face shields or visors. There are also goggles or glasses to protect the rider's eyes. Certain protective clothing, such as leather jackets, gloves and pants, keep the rider warm and also provide protection in case of a crash. There are a wide variety of products used by motorcycle riders to help improve performance and safety on the motorcycle.

### BRIEF SUMMARY OF THE INVENTION

A motorcycle has a frame, a steering assembly, an engine guard, a fairing upper and a fairing lower. The invention also includes a deflector which is positioned adjacent to the fairing lower. The deflector includes a hinge, so the deflector can be in an open-hinge position or a closed-hinge position. The deflector has a spring which urges the deflector into a closed-hinged position, and the spring is tensioned such that wind resistance moves the deflector from a closed-hinged position to an open-hinged position when the motorcycle reaches an open speed.

### BRIEF DESCRIPTION OF THE SEVERAL VIEWS OF THE DRAWINGS

FIG. 1 is a side view of a motorcycle.

FIG. 2 is a front view of a motorcycle with deflectors in a closed hinge position.

FIG. 3 is a front view of a motorcycle with deflectors in an open hinge position.

FIG. 4 is a perspective view of one embodiment of a deflector.

FIG. 5 is a side view of a deflector and portions of a fairing lower and a fairing upper, where the deflector is in a closed hinge position. Arrows indicate wind approaching the deflector.

FIG. 6 is a side view of a deflector and portions of a fairing lower and a fairing upper, where the deflector is in an open hinge position and the steering assembly has been turned to the light such that the fairing upper contacts the deflector plate.

FIG. 7 is side view of another embodiment of a deflector with a speedometer, a computer, and a portion of a fairing lower.

FIG. 8 is a perspective view of a deflector and a portion of a fairing lower, where the deflector is in the closed hinge position.

FIG. 9 is a perspective view of a deflector and a portion of a fairing lower, where the deflector is in the open hinge position.

### DETAILED DESCRIPTION

### The Motorcycle

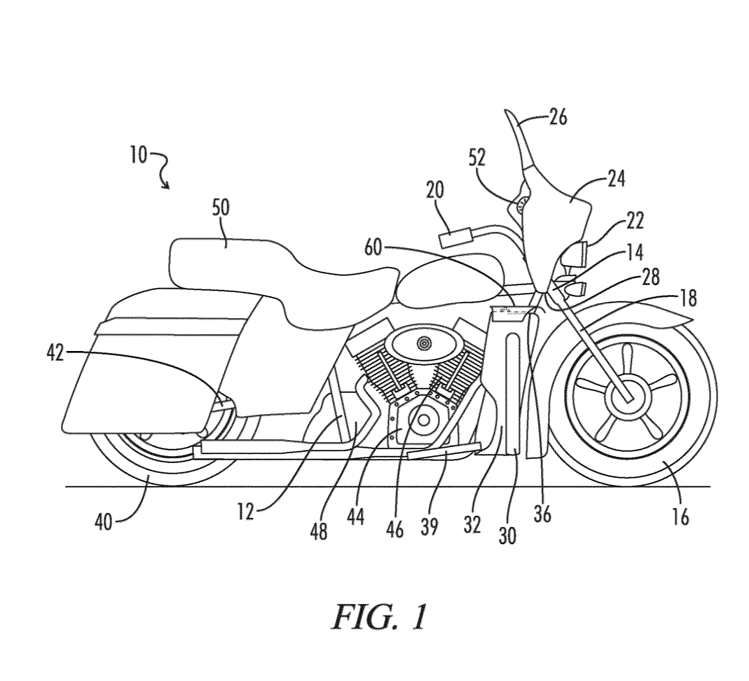

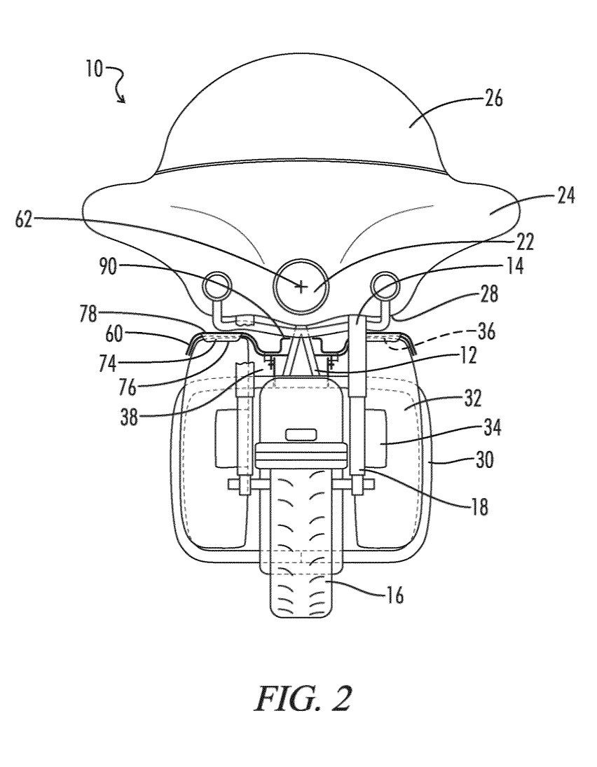

A motorcycle 10 is a vehicle having two wheels, as shown in FIGS. 1 and 2, however there are three wheeled versions of a motorcycle 10 which are sometimes referred to as “trikes.” A motorcycle 10 has many components, including a frame 12. A steering assembly 14 is pivotably connected to the frame 12 and is used for steering the motorcycle 10. The steering assembly 14 can be urged or pivoted to the left and right to steer the motorcycle 10. The steering assembly 10 typically includes a rotatably mounted front wheel 16, forks 18 which secure the front wheel 16 in position, and handlebars 20. A headlight 22 can be connected to the steering assembly 14 such that the headlight 22 pivots with the steering assembly 14. The forks 18 can include shock absorbers or other devices to absorb shocks, such as when the front wheel 16 hits a bump. Some of the controls for the motorcycle 10 can be included on the handlebars 20, such as a front brake, a clutch, and/or a throttle for fuel to the engine. Other controls can be accessed with the feet, such as a rear brake or the gear shifter. Other control configurations are possible

The steering assembly 14 can also have a fairing upper 24 connected to it. If the fairing upper 24 is directly connected to the steering assembly 14, the fairing upper 24 will pivot with the steering assembly 14. It is also possible to mount the fairing upper 24 such that the steering assembly 14 pivots independent of the fairing upper 24. The fairing upper 24 can include a windshield 26 which deflects air flow away from the rider. Fairing uppers 24 are generally designed to direct air flow for forward travel of the motorcycle 10, and not for backwards travel. The fairing upper 24 can include attached wings or other diverters. The fairing upper 24 also has a bottom edge 28, and wings or other diverters which are connected to the fairing upper 24 can become a part of the fairing upper bottom edge 28. The bottom edge 28 follows the contours along the bottom of the fairing upper 24, and there is not necessarily a clear demarcation where the bottom edge 28 transfers into a side portion of the fairing upper 24.

The motorcycle 10 can also include engine guards 30 which are connected to the frame 12. The engine guards 30 typically project from the side of the motorcycle 10 and do not pivot with the steering assembly 14. The engine guards 30 provide some protection for the engine should the motorcycle 10 fall over, and they can protect a rider's legs from being pinned between the engine and the ground. Engine guards 30 can be tubular in shape, but other shapes are also possible.

The motorcycle 10 includes fairing lowers 32 connected to the engine guards 30. There are a wide variety of fairings in existence, and in some examples the fairing lower 32 is connected directly to a fairing upper 24. The motorcycle 10 in this description has fairing lowers 32 which are not connected to the fairing upper 24. The motorcycle 10 in this description includes a fairing upper 24 which pivots with the steering assembly 14 and fairing lowers 32 connected to the engine guards 30, where the fairing lowers 32 do not pivot with the steering assembly 14. The fairing lowers 32 serve to direct air passing by the motorcycle 10.

In one embodiment, the fairing lowers 32 have vents 34 which can be manually opened or closed to adjust the amount of air contacting the rider's legs. These vents 34 are used to adjust the air flow and help establish a comfortable environment for the rider. The fairing lower 32 has a top end 36, which is the top portion of the fairing lower 32. In some embodiments there is an air channel 38 defined between the fairing lower 32 and the frame 12. As the motorcycle 10 moves forward, air can be funneled through the air channel 38. Frequently, air passing through the air channel 38 is deflected off of the fairing lower 32, the frame 12, or other portions of the motorcycle 10. A footboard 39 can be positioned behind the fairing lower 32, where the rider's feet rest on the footboard 39. The footboard 39 is near the bottom of the fairing lower 32, so little air flow passes between the footboard 39 and the fairing lower 32. Positioning the footboard 39 to limit air flow between the footboard 39 and fairing lower 32 can reduce the air flow on tile rider's legs.

The motorcycle 10 can also include a rotatable rear wheel 40 connected to frame 12. The rear wheel 40 is frequently connected to the frame 12 with a swing arm 42. There can be shock absorbers or other shock absorption devices used to allow vertical motion of the rear wheel 40. This absorbs bumps with the rear wheel 40 to provide a smoother ride for the user, as well as improving handling and traction for a safer ride.

The motorcycle 10 also has a drive train 44 which includes an engine 46 and a transmission 48. Fuel is burned in the engine 46 to provide the power for the motorcycle 10. The engine 46 powers the transmission 48, and the transmission 48 transfers the power to the rear wheel 40 to provide rotational motion. Generally, a belt or chain is used to transfer the power from the transmission 48 to the rear wheel 40. The drive train 44 is typically connected to the frame 12 with motor mounts, and these motor mounts can include a resilient material for reducing the transfer of engine vibrations to the frame 12.

The motorcycle 10 can also include other components, such as a seat 50 and a speedometer 52. The speedometer 52 measures the speed of the motorcycle 10, and can be tied to a computer or data processor to aid in operation of the motorcycle 10. The computer can control the fuel mixture fed to the engine 46, safety interlocks and other aspects of the operation of the motorcycle 10. The motorcycle 10 can include an electrical system with a battery, a headlight 22, and taillights. There can be saddlebags and a tour pak for storing gear, sissy bars, and many other components which depend on rider preferences and budgets.

The appearance of a motorcycle 10 can be very important to the motorcycle owner. Many motorcycle components are decorative or at least optional in nature, and can include chrome, special coloring, or painting. The motorcycle 10 frequently has a distinctive look which says something about the personality of the rider, and projects an image associated with the rider. People identify with their motorcycles 10, and appearance is an important part of this identification. The engine 46 is something which is typically not easily customizable, so the engine 46 can be used to identify a brand or model of motorcycle 10. Many people recognize the brand of motorcycle 10 based on the type of engine 46. Appearance affects sales of motorcycles 10, and motorcycle producers place great emphasis on appearance to keep sales strong and customers happy, and to project an image many find desirable.

### Deflector Function

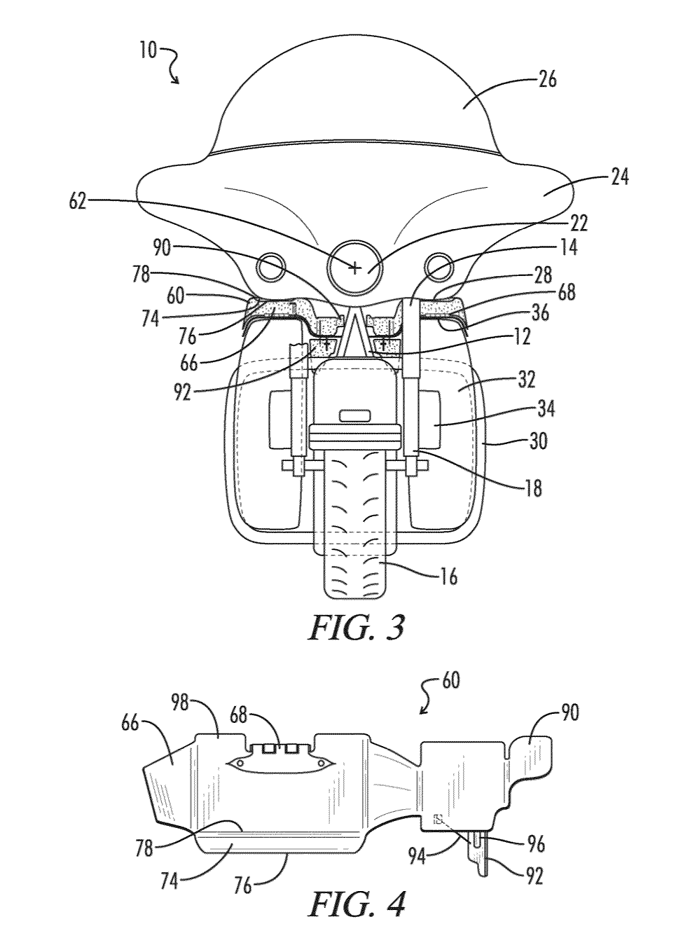

The motorcycle 10 of this disclosure includes deflectors 60 which use the science of aerodynamics to control and limit air flow between the fairing upper 24 and the fairing lower 32, as seen in FIGS. 2 and 3 with continuing reference to FIG. 1. There is a gap between the fairing upper 24 and the fairing lower 32, and air flow is common through this gap. The use of deflectors 60 to divert the air flow from this gap has benefits. One benefit is the stability of motorcycle 10 is improved. A deflector 60 in an open hinge position directs the air flow away from a motorcycle front end center point 62, and it has been observed that this does improve motorcycle stability. The open hinge position of the deflector 60 is discussed below. These observations are particularly noticeable in times of high turbulence, such as when driving a motorcycle 10 near trucks or other vehicles which cause wind shear and turbulent air.

The exact reason for the increased stability is not known for certain, but this disclosure provides a couple possibilities without verifying the accuracy of either possibility. In one hypothesis, the air flow striking the fairing lower 32 is directed downwards and underneath the motorcycle 10. This produces a wing-like effect where the air flow going underneath the fairing lower 32, the footboard 39, and the bottom of the motorcycle 10 travels at a higher speed than the air above the fairing lower 32, the footboard 39, and the motorcycle 10. The lower speed air above the footboard 39 and motorcycle 10 has a greater pressure than the higher speed air below the footboard 39 and motorcycle 10, providing a downward force. This effect is similar to the effect of a wing on race car. The faster the motorcycle 10 travels the greater the downward force, and the downward force provides stability and traction. The increased stability enhances motorcycle safety.

In an alternate hypothesis, the deflectors 60 produce a generally more aerodynamic shape for the motorcycle 10, resulting in less turbulence produced by the motorcycle 10. Without the deflectors 60, some of the air flow from the front of the motorcycle 10 passes through the gap between the fairing upper and lower 24, 32. With the deflectors 60, much of the air in front of the motorcycle 10 is deflected around the front profile of the motorcycle 10. The front profile and the general shape of the motorcycle 10 provide an air flow pattern similar to the air flow pattern from a teardrop shape. The teardrop shape has favorable aerodynamic properties, and produces less turbulence than many other shapes. The gap without the deflectors 60 in the front profile of the motorcycle 10 provides an air flow pattern around the motorcycle 10 that may be a less aerodynamic flow pattern. A less aerodynamic flow pattern causes more turbulence in the air. The reduced turbulence when the deflectors 60 block the gap between the fairing upper and lower 24, 32 may provide a more stable ride. There are other possible effects or combinations of effects which may explain the increased stability from the use of deflectors 10, and this description does not purport to know the exact mechanism providing the more stable ride.

Another benefit of using the deflectors 60 is improved comfort and safety for the rider. Air flow passing between the fairing upper and lower 24, 32 tends to impact the rider, particularly around the head and face. Extended riding with high winds in the face tends to be fatiguing, so one may stay fresher when riding a motorcycle 10 with a deflector 60 limiting this air flow. Also, the reduced air flow buffeting the rider in the head and face results in fewer impacts to the rider from thing such as rain, water or even bugs or other objects on the road.

### Deflector Description

The deflectors 60 of this invention are positioned adjacent to the fairing lower top end 36. The deflectors 60 can include a bracket 64 for mounting, but in some embodiments the deflector 60 can be mounted without a bracket 64. The bracket 64 can be mounted to the frame 12 or to other components of the motorcycle 10, with the bracket 64 holding the deflector 60 adjacent to the fairing lower 32. Alternatively, the deflector 60 may be attached directly to the fairing lower top end 36, the engine guard 30, and/or the frame 12 without the use of a bracket 64. The deflector 60 may have additional attachment points, such as to side surfaces or other surfaces of the fairing lower 32. It is also possible to use a bracket 64 and have other attachment points which are not part of the bracket 64.

The deflector 60 includes a deflector plate 66 to control and obstruct air flow, and the deflector plate 66 can have many shapes. One embodiment is shown in FIG. 4, with continuing reference to FIGS. 1-3. The deflector plate 66 can go down the sides of the fairing lower 32 to some extent, or they can remain primarily or exclusively on the fairing lower top end 36. The deflector plate 66 can be flat and mounted strictly to the fairing lower top end 36. The deflector plate 66 can also have flat sections which are angled together to form a cup type shape. The deflector plate 66 can have a curved shape which is formed to match the contours of the fairing lower top end 36. The deflector plate 66 can have a curved shape which is somewhat different than the shape of the fairing lower top end 36. The deflector plate 66 can be curved from left to right, from front to back, or both; it can be curved consistently, it can have varying curvature, it can have adjoining straight sections, or any combination of these shapes. The deflector plate 66 can have any of a wide range of shapes. It has been observed that a deflector plate 66 which extends at least somewhat down the sides of the fairing lower 32 provides more stability than a flat deflector plate 66.

The deflector 60 also includes a hinge 68. In one embodiment, the hinge 68 is mounted near the back portion of the deflector plate 66 so there is more of the deflector plate 66 in front of the barrel of the hinge 68 than behind it. The deflector plate 66 pivots about the barrel of the hinge 68. The deflector 60 has a closed hinged position in which the deflector plate 66 remains close to the fairing lower top end 36 such that the deflector plate 66 hugs the fairing lower top end 36. The deflector 60 also has an open hinge position in which the deflector plate 66 is lifted up and away from the fairing lower top end 36. FIG. 2 shows the deflector plate 66 in the closed hinge position, and FIG. 3 shows the deflector plate 66 in the open hinge position. In the open hinge position the front portion of deflector plate 66 is further from the fairing lower top end 36 than the back portion of the deflector plate 66 because the hinge 68 is closer to the back end of the deflector plate 66. The deflector 60 can also include a stop to prevent the hinge 68 from opening more than a set amount, and thus set a defined end position of the deflector plate 66 when the deflector 60 opens.

### Deflector Automatic Operation

The deflector 60 of the current invention automatically moves from a closed hinge position to an open hinged position. When reference is made to the deflector 60 automatically moving in this description, it means the deflector 60 moves without any manual operation by the rider or anyone else, and without any specific action by the rider directed toward operation of the deflector 60. Increasing or decreasing the speed of the motorcycle 10 is not considered an action directed toward operation of the deflector 60.

In one embodiment, the deflector 60 automatically moves from the closed hinged position to the open hinged position when the motorcycle 10 faces sufficient wind resistance. The motorcycle 10 will generally face sufficient wind resistance at approximately an open speed, where the open speed is the speed of the motorcycle 10 when the deflector 60 opens. The two primary sources of wind resistance for a motorcycle 10 are from the motion of the motorcycle, and from natural wind. The open speed will vary depending on the natural, ambient wind present. It is understood that a headwind will cause an apparent wind higher than the speed of the motorcycle 10, and a tail wind will cause an apparent wind lower than the speed of the motorcycle 10. Other factors could change the open speed, such as variations in air pressure caused by varying elevations. In general, references made in this description to an open speed are based on no natural wind and air pressure at sea level. In alternate embodiments, the open speed can be based more directly on motorcycle speed, such as by utilizing the speedometer 52 to control the deflector movements.

It has been noticed that air movement from natural wind has less of an effect on the deflector 60 than air movement from the motion of the motorcycle 10. This is presumably due to the velocity profile of the wind approaching the motorcycle 10, where natural wind approaching the motorcycle will have higher speeds further from the ground. Natural wind tends to have a lower speed near the ground, and higher speeds farther off of the ground. This gives a curved wind velocity profile, where the velocity of the wind near the ground is low and the velocity of the wind increases with increased distance from the ground. When the motorcycle 10 moves forward, the apparent wind is the same at all levels because the motorcycle to is moving through the air. Therefore, the air velocity at the ground relative to the motorcycle 10 is approximately the same as the air velocity at the head of the rider, or at the highest point on the motorcycle 10. The air velocity at the fairing lower 32 under the deflector 60 has a large effect on the deflector operation.

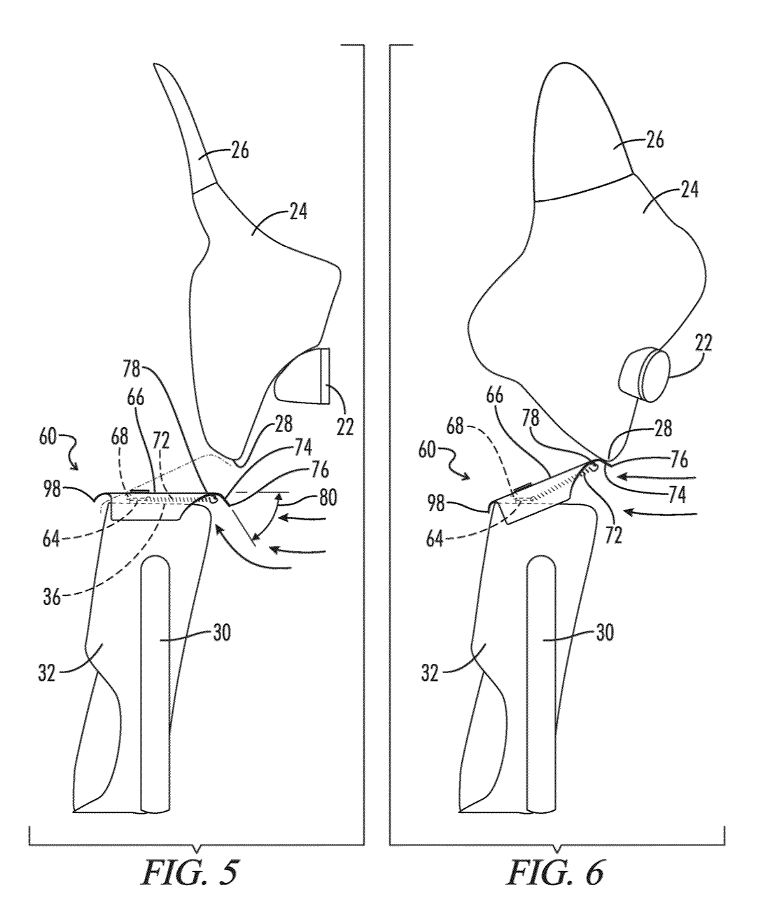

Different embodiments of the invention use different methods to automatically open the deflector 60, where opening the deflector 60 refers to moving the deflector 60 from the closed hinged position to the open hinge position. In one embodiment, the deflector 60 includes a spring 72, as seen in FIGS. 5 and 6. The spring 72 is connected to the deflector plate 66, and the spring 72 urges the deflector plate 66 towards a closed hinged position. The tension of the spring 72 is set such that when the motorcycle 10 reaches an open speed, there is sufficient wind resistance to overcome the tension force of the spring 72 and open the deflector 60. When the motorcycle speed falls, the wind resistance falls and the deflector 60 moves from the open hinge position to the closed hinge position. The spring 72 could be a coil spring, a V spring, a leaf spring, or any of a wide variety of springs. The spring 72 could be connected to the deflector plate 66 with a bracket, tab, or other device, such that the spring is connected to the deflector plate 66 through another component.

The deflector 60 is designed such that the deflector plate 66 catches wind as the motorcycle 10 goes faster, where reference is now made to FIG. 5. In one embodiment, the deflector plate 66 includes a front lip 74 with a leading edge 76 and a trailing edge 78. The front lip 74 can be set at a downward angle such that in the closed hinged position the front lip leading edge 76 is below the front lip trailing edge 78. Wind or air approaching the deflector 60 horizontally will be deflected over the top of deflector plate 66 by the front lip 74 when in the closed hinge position, as shown by the essentially horizontal arrow in FIG. 5 indicating wind approaching the deflector 60. Air approaching the deflector plate 66 from below at an angle greater than an opening angle 80 strikes the bottom portion of the deflector plate 66 and is deflected under the deflector plate 66, as shown by the curved arrow in FIG. 5 indicating wind deflected by the fairing lower 32 approaching the deflector 60 from below. The downward angle of the front lip 74 is the opening angle 80. Air passing over the deflector plate 66 urges the deflector 60 towards a closed hinge position, and air passing under the deflector plate 66 urges the deflector 60 to an open hinge position.

As the motorcycle 10 travels, the air approaching the fairing lower 32 is deflected away from the fairing lower 3. Air flow near the fairing lower top end 36 tends to be directed upwards, and this produces air flow approaching the deflector plate 66 from below. When this air flow reaches a large enough angle, which is an angle greater than the opening angle 80, it strikes the bottom of the deflector plate 66 and provides a force urging the deflector 60 into an open hinge position. At low enough speeds the air flow tends to strike the deflector 60 at a more horizontal angle, so at slower speeds the air flow tends to urge the deflector 60 into a closed hinge position. As the air speed increases, the angle at which air flow approaches the deflector 60 also increases. By setting the opening angle 80 of the front lip 74 in conjunction with the tension on the spring 72, one can set an approximate open speed at which the deflector 60 will open. In one embodiment, the open speed is between 40 kilometers an hour and 50 kilometers per hour.

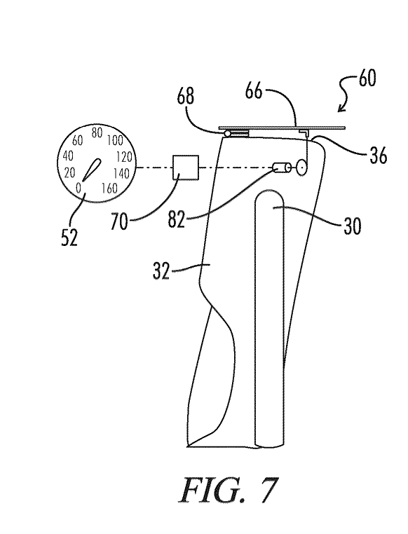

In an alternate embodiment, the deflector plate 66 is relatively flat and air impacting the deflector plate 66 causes a lifting force whenever tile flow is coming upwards from below the deflector plate 66. The open speed is then controlled primarily by the tension of the spring 72. In another embodiment shown in FIG. 7, there is an electric motor 82 used to open the deflector 60. The electric motor 82 is connected to the speedometer 52, and the open speed is programmed into a computer 70, on-board processor, or similar device on the motorcycle 10. When the speedometer 52 indicates the motorcycle 10 has reached the open speed, the electric motors connected to the deflector plate 66 are engaged and open the deflector 60. When the speedometer 52 indicates the motorcycle 10 has fallen below a closed speed, the electric motors 82 are engaged in reverse and close the deflector 60 from the open hinge position to the closed hinged position. In other embodiments, the motors 82 could be replaced with a hydraulic system or with a clutch and a direct connection to the engine 46. The spring 72 could be replaced with a weight in an alternative embodiment. A wide variety of options are available for automatically opening or closing the deflector 60 at the open speed.

The deflector 60 has different effects based on the position of the deflector 60, as seen in FIGS. 2, 3, 5 and 6, with continuing reference to FIG. 1. In the closed hinged position, the deflector 60 has very little effect because the deflector plate 66 hugs the fairing lower top end 36. In one embodiment, the front lip leading edge 76 is a maximum of 1.5 centimeters from the fairing lower 32 when the deflector 60 is in the closed hinge position. In the open hinge position, the deflector 60 has a much larger impact on air flow around the motorcycle 10.

A deflector 60 for directing air flow becomes more significant as the motorcycle speed increases, because the air flow rate tends to increase with increased motorcycle speed. At low speeds, the deflector 60 has little effect because there is little air flow to be controlled. A deflector 60 for controlling air flow does little in still air. Therefore, leaving the deflector 60 in the closed hinge position at low speeds does not significantly reduce the effectiveness of the deflector 60 because there is little air flow to be controlled. The air velocity increases as the motorcycle 10 travels faster. When the motorcycle 10 speeds up to the open speed, the deflector 60 automatically opens. The open speed can be set at a speed where the deflector 60 has a more noticeable effect. In the open hinge position, the deflector 60 reduces air flow between the fairing upper 24 and the fairing lower 32. This produces a noticeable increase in stability of the motorcycle 10, and reduces turbulent air impacting the rider.

### Defector and Fairing Upper Contact

In some embodiments, the deflector plate 66 can contact the fairing upper bottom edge 28. The fairing lowers 32 and the deflectors 60 can be positioned such that the fairing upper 24 is positioned directly over them at least at some point within the range of motion of the steering assembly 14. Positioning the deflector 60 within the range of motion of the fairing upper 24 leaves a smaller space between the failing upper 24 and the deflector 60 than if the deflector 60 were positioned further from the fairing upper 24. Less air flow is allowed between the deflector plate 66 and the fairing upper 24 when the space between the deflector plate 66 and fairing upper 24 is smaller.

In some embodiments, the deflector 60 in the open hinge position will have at least a portion of the deflector plate 66 higher than the fairing upper bottom edge 28. In particular, in one embodiment the front lip trailing edge 78 is higher than the fairing upper bottom edge 28 when the deflector 60 is in the open hinge position. This can result in contact between the fairing upper bottom edge 28 and the deflector plate 66 if the steering assembly 14 is rotated sharply enough while the deflector 60 is open. The fairing upper bottom edge 28 can contact the deflector plate 66 because the deflector plate 66 can be within the range of motion of the fairing upper 24, and the front lip trailing edge 78 of the deflector plate 66 is higher than the fairing upper bottom edge 28 when the deflector 60 is in the open hinge position. The steering assembly 14 is in a contact position when the fairing upper 24 contacts the deflector plate 66.

The deflector plate 66 can be designed so tile range of motion of the steering assembly 14 is not limited by contact with the deflector plate 66. To prevent interference with motorcycle steering, the front lip 74 can be designed such that the leading edge 76 is below the fairing upper bottom edge 28 when the deflector 60 is in the open hinge position. When the deflector 60 is in the open hinge position, the front lip leading edge is below the fairing upper bottom edge 28 but the front lip trailing edge 78 is above the fairing upper bottom edge 28. Positioning the front lip leading edge 76 below the front lip trailing edge 78 provides a downward angle of the front lip 74.

Contact between the fairing upper 24 and the deflector plate 66 is between the front lip leading and trailing edges 76, 78. Continued rotation of the steering assembly 14 pushes the deflector plate 66 downward and out of the way of the fairing upper 24. At least a portion of the deflector plate 66 extends to a position higher than the fairing upper bottom edge 28 to more effectively control air flow, yet the deflector 60 does not restrict rotation of the steering assembly 14. In the closed hinged position, the deflector plate 66 hugs the fairing lower top end 36 and all portions of the deflector plate 66 are below the fairing upper bottom edge 28. Therefore, in the closed hinged position the deflector 60 does not interfere with rotation of the steering assembly 14.

When riding a motorcycle 10, the effective range of motion of the steering assembly 14 changes as the speed of the motorcycle 10 changes. When driving at very low speeds, the rider is able to use a wide range of motion for the steering assembly 14, and sharp turns are possible. As speed increases, the usable range of motion of the steering assembly 14 decreases, and one cannot safely perform very sharp corners at high speeds. Therefore, when the speed of the motorcycle 10 becomes large enough, the effective range of motion of the steering assembly 14 can become limited such that the fairing upper 28 does not move into the contact position with the deflector 60. The deflector 60 does not interfere with steering because it is in the closed hinge position at low speeds where the steering assembly 14 has an affective large range of motion. The deflector 60 does not open until the motorcycle 10 reaches an open speed where the effective range of motion of the steering assembly 14 is limited. The open speed and the position of the deflector 60 can be set such that the effective range of motion of the steering assembly 14 provides minimal chance of contact between the deflector plate 66 and the fairing upper bottom edge 28.

The automatic opening and closing of the deflector 60 allows for limiting at least some of the air flow between the fairing upper 24 and fairing lower 32 without interfering with the steering of the motorcycle 10. Any hazards from wind or other effects causing the deflector 60 to open are minimized because the fairing upper 24 pushes the deflector plate 66 down and out of the way if contact is made.

### Deflector Improvements

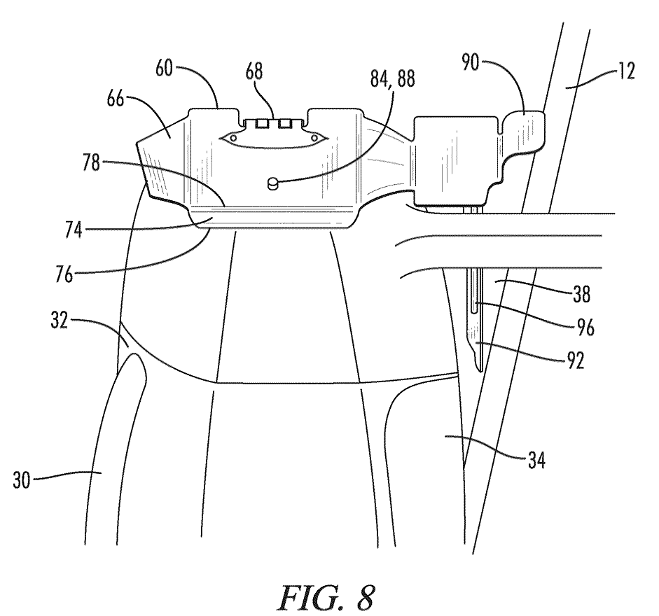

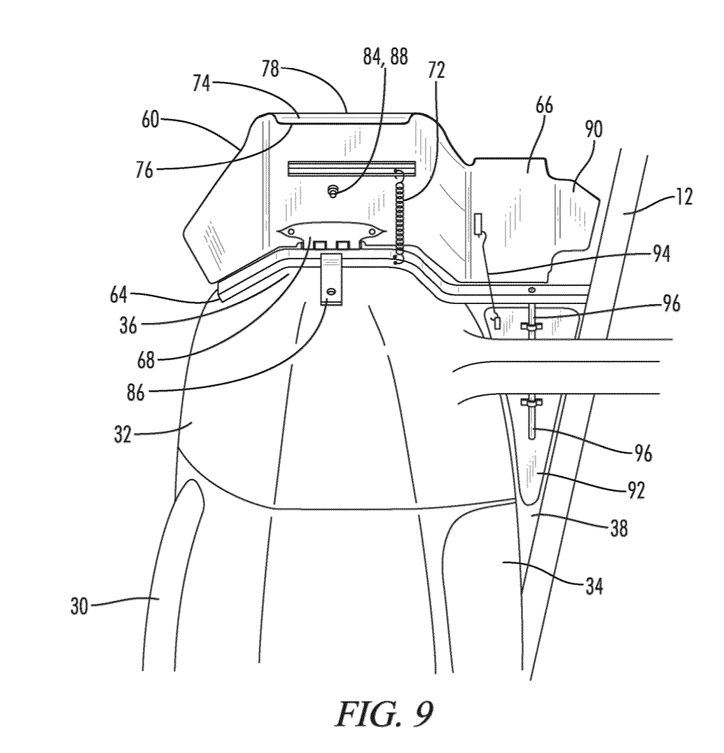

In some embodiments, the deflector 60 can include a lock 84 for securing the deflector 60 in a set position, as seen in FIGS. 8 and 9 with continuing reference to FIGS. 2 and 3. In one embodiment, the lock 84 includes a threaded piece 88 passing through the deflector plate 66 and screwing into a lock plate 86 positioned below the deflector plate 66. The top portion of the threaded piece 88 is above the deflector plate 66 and cannot pass through the deflector plate 66, so the top portion of the threaded piece 88 holds the deflector plate 66 down. The bottom portion of the threaded piece 88 secures into the lock plate 86 below the deflector plate 66, so the threaded piece 88 holds the deflector plate 66 against the lock plate 86. This embodiment secures the deflector plate 66 in the closed hinge position. Other types of locks 84 can also be used, such as a latch, a wedge, or other devices. It is also possible to design a lock 84 which will lock the deflector 60 in various positions, including the open hinge position, the closed hinge position and intermediate positions between tile open hinged and the closed hinged positions.

The deflector 60 can be designed to include access for the deflector bracket 64. In one embodiment, the deflector plate 66 includes a raised portion 90 over access points to the deflector bracket 64. The raised portion 90 provides access to the deflector plate bracket 64 for maintenance, installation, etc.

The deflector 60 can also include a pivot plate 92 to limit air flow through the air channel 38. A tie rod 94 is connected to the pivot plate 92, and the tie rod 94 can also be connected to the deflector plate 66, the hinge 68, or other moving components of the deflector 60. The tie rod 94 serves to coordinate the motion of the pivot plate 92 and the deflector plate 66, so the tie rod 94 could be replaced with a push rod, cam or other device in alternative embodiments. In one embodiment, the pivot plate 92 moves to a closed position which limits flow through the air channel 38 when the deflector 60 opens. This further restricts air flow close to the motorcycle front end center point 62, and can help to improve motorcycle stability. The tie rod 94 also moves the pivot plate 92 into an open position, which allows air flow through the air channel 38, when the deflector plate 66 moves to a closed hinged position.

The pivot plate 92 can be operated in a variety of manners. In one embodiment, the deflector 60 includes a pivot rod 96 connected to the pivot plate 92. The pivot plate 92 pivots about the pivot rod 96. The pivot plate 92 could also be mounted on a hinge or a screw-type mechanism, or any of a wide variety of mechanisms such that the pivot plate 92 moves into a closed position when the deflector 60 opens. In alternate embodiments, the pivot plate 92 could be a plurality of pivot plates 92 for controlling air flow in a plurality of locations, because there could be more than one location allowing air flow within the area protected by the fairings 24, 32.

The deflector plate 66 can include a back lip 98 to further improve efficiency, as seen in FIGS. 5 and 6. The back lip 98 can be curved downward with a back lip angle such that when the deflector plate 66 is in the open hinge position, the back lip 98 tends to form a more complete air blockage than if the back lip 98 were straight or non-existent. The back lip 98 can extend behind the barrel of the hinge 68 to help reduce air flow between the deflector plate 66 and the fairing lower top end 36.

While the invention has been described with respect to a limited number of embodiments, those skilled in the art, having the benefit of this disclosure, will appreciate that other embodiments can be devised which do not depart from the scope of the invention as disclosed here. Accordingly, the scope of the invention should be limited only by the attached claims.

I claim:

1. A motorcycle including:
a frame;
a steeling assembly pivotably connected to the frame;
a fairing upper connected to the steering assembly, the fairing upper including a bottom edge;
an engine guard connected to the frame;
a fairing lower connected to the engine guard, the fairing lower having a top end; and
a deflector positioned adjacent to the fairing lower top end, the deflector including a hinge such that the deflector has a closed hinge position and an open hinge position, where the deflector includes a deflector plate with a front lip angled downward such that air horizontally approaching the deflector plate is deflected over the deflector plate and air approaching the deflector plate from below an opening angle is deflected under the deflector plate, where the front lip has a leading edge and a trailing edge and the leading edge is lower than the fairing upper bottom edge when the deflector is in the open hinge position and the trailing edge is higher than the fairing tipper bottom edge in the open hinge position such that pivoting the steering assembly with the deflector in the open hinge position causes contact between the fairing upper bottom edge with the front lip between the leading and trailing edges, the deflector further comprising a spring connected to the deflector plate where the spring urges the deflector plate towards the closed hinge position, and where the spring is tensioned such that sufficient wind resistance overcomes the spring tension and moves the deflector from the closed hinge position to the open hinge position.

2. A motorcycle comprising:
a frame;
a steering assembly pivotably connected to the frame;
a fairing upper connected to the steering assembly;
an engine guard connected to the frame;
a fairing lower connected to the engine guard, the fairing lower having a top end; and
a deflector positioned adjacent to the fairing lower top end, the deflector including a hinge such that the deflector has a closed hinge position and an open hinge position; and
means for automatically moving the deflector from the closed hinge position to the open hinge position based on motorcycle speed.

3. The motorcycle of claim 2 further comprising means for automatically moving the deflector from the open hinge position to the closed hinge position based on motorcycle speed.

4. A motorcycle comprising:
a frame;
a steering assembly pivotably connected to the frame;
a fairing upper connected to the steering assembly, the fairing upper having a bottom edge;
an engine guard connected to the frame;
a fairing lower connected to the engine guard, the fairing lower having a top end; and
a deflector positioned adjacent to the fairing lower top end, the deflector including a hinge such that the deflector has an open hinge position and a closed hinge position, the deflector including a deflector plate having a front lip, the front lip including a leading edge and a trailing edge, where the front lip training edge is higher than the fairing upper bottom edge when the deflector is in the open hinge position.

5. The motorcycle of claim 4 where the front lip leading edge is lower than the fairing upper bottom edge when the deflector is in the open hinge position.

6. The motorcycle of claim 5 where the steering assembly has a range of motion including a contact position where the fairing upper bottom edge contacts the deflector plate when the deflector is in the open hinge position.

7. The motorcycle of claim 4 further comprising a spring connected to the deflector plate, the spring urging the deflector towards a closed hinge position where the spring is tensioned such that sufficient wind resistance overcomes the spring tension and moves the deflector to an open hinge position.

8. The motorcycle of claim 7 where the spring is a V spring.

9. The motorcycle of claim 4 where the fairing lower and the frame define an air channel, and the deflector further comprises a pivot plate and a tie rod connecting the deflector plate to the pivot plate, where the tie rod moves the pivot plate to a closed position in the air channel as the deflector moves to the open hinge position, and where the tie rod moves the pivot plate to an open position as the deflector moves to the closed hinge position.

10. The motorcycle of claim 4 where the deflector plate includes a back lip with a back lip angle.

11. The motorcycle of claim 4 where the front lip leading edge is within 1.5 centimeters of the fairing lower when the deflector is in the closed hinge position.

12. A motorcycle comprising:
a frame;
a steering assembly pivotably connected to the frame;
a fairing upper connected to the steering assembly;
an engine guard connected to the frame;
a fairing lower connected to the engine guard; and
a deflector positioned adjacent to the fairing lower, the deflector including a hinge such that the deflector has an open hinge position and a closed hinge position, the deflector also having a spring urging the deflector into a closed hinge position where the spring is tensioned such that sufficient wind resistance moves the deflector from a closed hinge position to an open hinge position.

13. The motorcycle of claim 12 where sufficient wind resistance is provided at an open speed, and the open speed is between 40 kilometers per hour and 50 kilometers per hour.

14. The motorcycle of claim 12 where the deflector further comprises a deflector plate having a front lip, and where the front lip is angled downward such that air horizontally approaching the deflector plate is deflected over the deflector plate and air approaching the deflector plate from below an opening angle is deflected under the deflector plate.

15. The motorcycle of claim 14 where the fairing upper further comprises a fairing upper bottom edge, and the front lip includes a trailing edge, and the front lip trailing edge is higher than the fairing upper bottom edge when the deflector is in the open hinge position.

16. The motorcycle of claim 15 where the front lip includes a leading edge, and the leading edge is lower than the fairing upper bottom edge when the deflector is in the open hinge position.

17. The motorcycle of claim 12 where the fairing lower and the frame define an air channel, the deflector further comprising a deflector plate, a pivot plate, and a tie rod, where the tie rod connects the pivot plate to the deflector plate such that the pivot plate moves to a closed position in the air channel as the deflector moves to the open hinge position, and the pivot plate moves to an open position as the deflector moves to the closed hinge position.

18. The motorcycle of claim 17 where the deflector further comprises a pivot rod, and the pivot plate is connected to the pivot rod.

19. The motorcycle of claim 12 where the spring is a coil spring.

20. The motorcycle of claim 12 where the deflector further comprises a lock to secure the deflector in a set position.

21. A method of stabilizing a moving motorcycle comprising:
providing a motorcycle with a deflector mounted on a fairing lower, where the deflector has an open hinge position and a closed hinge position;
moving the deflector from the closed hinge position to the open hinge position automatically when the motorcycle reaches an open speed; and
deflecting air away from a motorcycle front end center point when the deflector is in the open hinge position.
